(19) United States
(12) Patent Application Publication
(10) Pub. No.: US 2016/0172141 A1
(43) Pub. Date: Jun. 16, 2016

(54) FUSIBLE LINK

(71) Applicant: YAZAKI CORPORATION, Tokyo (JP)

(72) Inventors: Shinya ONODA, Shizuoka (JP); Norio MATSUMURA, Shizuoka (JP); Yoshinori ISHIKAWA, Shizuoka (JP); Norihiro OHASHI, Shizuoka (JP)

(73) Assignee: YAZAKI CORPORATION, Tokyo (JP)

(21) Appl. No.: 14/966,095

(22) Filed: Dec. 11, 2015

(30) Foreign Application Priority Data
Dec. 12, 2014 (JP) 2014-251718

(51) Int. Cl. H01H 85/055; H02H 7/18

(52) U.S. Cl. CPC H01H 85/055; H02H 7/18; H01H 2231/026

(57) ABSTRACT

A fusible link includes a power supply portion provided on a connection terminal that is formed of conductive metal and connects to a battery terminal; a circuit terminal that is formed of conductive metal in a plate shape and connects to a circuit; and a fuse element that is formed of conductive metal, connects the power supply portion and the circuit terminal in a belt-like shape that is narrower in width than the power supply portion and the circuit terminal, and fuses when a current equal to or greater than a threshold value flows, and in the fusible link, the fuse element has a shape projecting in an out-of-plane direction of a terminal mounting surface of a battery.

### CROSS-REFERENCE TO RELATED APPLICATION(S)

The present application claims priority to and incorporates by reference the entire contents of Japanese Patent Application No. 2014-251718 filed in Japan on Dec. 12, 2014.

### BACKGROUND OF THE INVENTION

1. Field of the Invention

The present invention relates to a fusible link for preventing a current greater than a specified value from flowing into a circuit for a vehicle, for example.

2. Description of the Related Art

Conventionally, the power supply to a circuit in a vehicle from a battery is often conducted via a fusible link in order to prevent a current greater than a specified value from flowing into the circuit (see Japanese Patent Application Laid-open No. 2011-222189, for example).

In FIG. 10, one example of a fuse unit including a conventional fusible link is illustrated in three orthographic views. This fuse unit 7 illustrated in FIG. 10 is the one that is directly mounted on a rod-shaped electrode 82 projecting from a terminal mounting surface 81 of a battery 8, and includes a battery terminal 71 and a fusible link 72.

The battery terminal 71 is a terminal having a substantially rectangular shape in planar view, and on one end side in the longitudinal direction thereof, an electrode insertion hole 711 into which the rod-shaped electrode 82 of the battery 8 is inserted is provided. On the other end side in the longitudinal direction, a screw 712 to couple the battery terminal 71 and the fusible link 72 together is provided. The battery terminal 71 is connected to the rod-shaped electrode 82 of the battery 8 near the one end, and extends toward the other end toward an outer edge 81a of the terminal mounting surface 81.

The fusible link 72 is formed with a power supply portion 721, two circuit terminals 722, and fuse elements 723 provided on a connection terminal 73 and housed inside a resin housing 724 composed of insulating resin material. In FIG. 11, illustrated is a structure object including the power supply portion, the two circuit terminals, and the fuse elements provided on the connection terminal in the fusible link illustrated in FIG. 10.

To the connection terminal 73, the battery terminal 71 is connected. On this connection terminal 73, provided is an insertion hole 73a into which the screw 712 of the battery terminal 71 is inserted. The screw 712 inserted into this insertion hole 73a is fastened with a nut 713, and thereby the battery terminal 71 is connected to the connection terminal 73.

The power supply portion 721 is provided on the connection terminal 73 in an integrated manner, and is supplied with the electrical power via the battery terminal 71 and the connection terminal 73.

On each of the two circuit terminals 722, a circuit that operates by the electrical power from the battery 8 is connected. On each circuit terminal 722, provided is a connection screw 722a to connect a round terminal and the like of an electrical wire constituting the circuit, for example. On the circuit terminal 722, formed is an insertion hole 722b into which this connection screw 722a is inserted. The circuit terminal 722 is housed inside the resin housing 724 in a state that the connection screw 722a is being inserted into the insertion hole 722b.

The fuse element 723 is formed connecting the power supply portion 721 and each of the two circuit terminals 722 in a belt-like shape narrower in width than the power supply portion 721 and the circuit terminal 722. Into each of the circuit terminals 722, the current from the battery 8 flows from the power supply portion 721 via the fuse element 723. When a current equal to or greater than a threshold value flows, the fuse element 723 fuses, and thereby an excessive current is prevented from flowing into the circuit.

The fusible link 72, as in the foregoing, is formed with the power supply portion 721, the two circuit terminals 722, and the fuse elements 723 formed of conductive metal and provided on the connection terminal 73 and housed inside the resin housing 724 composed of insulating resin material. The resin housing 724 is formed by insert molding in which the power supply portion 721, the two circuit terminals 722, and the fuse elements 723 provided on the connection terminal 73 are covered with and fixed (being molded) by the insulating resin material, for example. The resin housing 724 including insulating resin material covers and fixes parts of the circuit terminals 722, the fuse elements 723, and the power supply portion 721 provided on the connection terminal 73, in a state that the respective connection surfaces of the connection terminal 73 and the circuit terminals 722 are exposed and windows 724a are provided such that the fusing of the fuse elements 723 is visible. On the window 724a for visible recognition of fusing, a transparent cover 725 is put on, and the fusing of the fuse element 723 is visible through this transparent cover 725.

In recent years, space-saving in vehicles has been progressed and spatial allowance in the periphery of a battery installed has been dwindling, and thus downsizing of a fusible link that tends to occupy the space near the rod-shaped electrode of the battery has been required.

### SUMMARY OF THE INVENTION

Consequently, being focused on the foregoing problem, an object of the present invention is to provide a downsized fusible link.

In order to achieve the above mentioned object, a fusible link according to one aspect of the present invention includes a power supply portion provided on other end side of a battery terminal that is formed of conductive metal, connected at and near one end of the battery terminal to a rod-shaped electrode projecting from a terminal mounting surface of a battery, and extending toward an outer edge of the terminal mounting surface toward the other end of the battery terminal, or provided on a connection terminal that is formed of conductive metal in a plate shape, disposed substantially in parallel with the terminal mounting surface, and connected to the other end side of the battery terminal; a circuit terminal connected to a circuit that is operated by electrical power from the battery; and a fuse element that is formed of conductive metal, connecting the power supply portion and the circuit terminal in a belt-like shape narrower in width than the power supply portion and the circuit terminal, and fusing when a current equal to or greater than a threshold value flows, wherein the fuse element has a shape projecting in an out-of-plane direction with respect to at least one surface of the terminal mounting surface and a surface of the circuit terminal.

According to another aspect of the present invention, in the fusible link, the power supply portion may include a power-supply body portion, and a power-supply arm portion extending from the power-supply body portion in an intersecting direction that intersects with an extending direction of the battery terminal and is substantially in parallel with the terminal mounting surface, the circuit terminal may include a circuit terminal body disposed in front leaving a gap with the power-supply body portion in the extending direction viewed from the power-supply body portion, and a circuit-terminal arm portion extending from the circuit terminal body to a position being adjacent to the power-supply arm portion leaving a gap with the power-supply arm portion, and the fuse element may connect the power-supply arm portion and the circuit-terminal arm portion.

According to still another aspect of the present invention, in the fusible link, the fuse element may connect an edge of the front side in the extending direction of the power-supply arm portion and an edge of a rear side in the extending direction of the circuit-terminal arm portion.

According to still another aspect of the present invention, in the fusible link, the circuit terminal may be disposed in front leaving a gap with the power supply portion in an extending direction of the battery terminal viewed from the power supply portion, and the fuse element may connect the power supply portion and the circuit terminal.

According to still another aspect of the present invention, in the fusible link, the fuse element may connect an edge of a front side in the extending direction of the power supply portion and an edge of a rear side in the extending direction of the circuit terminal.

According to still another aspect of the present invention, in the fusible link, the power supply portion may be provided on the connection terminal and connected to the battery terminal on a surface on an opposite side of a projecting side of the fuse element out of front and rear surfaces of the connection terminal, and the battery terminal may be connected to the surface on the opposite side such that the battery terminal sticks out toward the gap from the power supply portion to a position overlapping the fuse element when viewed from the out-of-plane direction.

The above and other objects, features, advantages and technical and industrial significance of this invention will be better understood by reading the following detailed description of presently preferred embodiments of the present invention, when considered in connection with the accompanying drawings.

### BRIEF DESCRIPTION OF THE DRAWINGS

FIG. 1 is three orthographic views illustrating a fuse unit including a fusible link according to a first embodiment;

FIG. 2 is three orthographic views illustrating the fusible link illustrated in FIG. 1;

FIG. 3 is a planar view illustrating a structure object including a power supply portion, two circuit terminals, and fuse elements provided on a connection terminal in the fusible link illustrated in FIGS. 1 and 2;

FIG. 4 is a perspective view illustrating the structure object illustrated in FIG. 3;

FIG. 5 is three orthographic views illustrating a fuse unit including a fusible link according to a second embodiment;

FIG. 6 is three orthographic views illustrating the fusible link illustrated in FIG. 5;

FIG. 7 is a planar view illustrating a structure object including a power supply portion, two circuit terminals, and fuse elements provided on a connection terminal in the fusible link illustrated in FIGS. 5 and 6;

FIG. 8 is a perspective view illustrating the structure object illustrated in FIG. 7;

FIG. 9 is a side view illustrating the positional relation between the fuse element and a battery terminal illustrated in FIGS. 7 and 8;

FIG. 10 is three orthographic views illustrating one example of a fuse unit including a conventional fusible unit; and

FIG. 11 is a planar view illustrating a structure object including a power supply portion, two circuit terminals, and fuse elements provided on a connection terminal in the fusible link illustrated in FIG. 10.

### DETAILED DESCRIPTION OF THE PREFERRED EMBODIMENTS

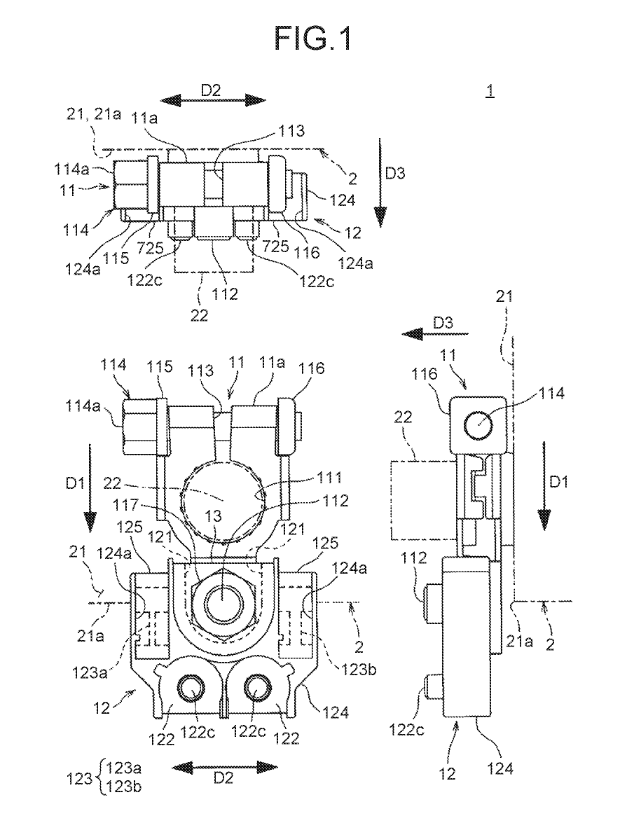

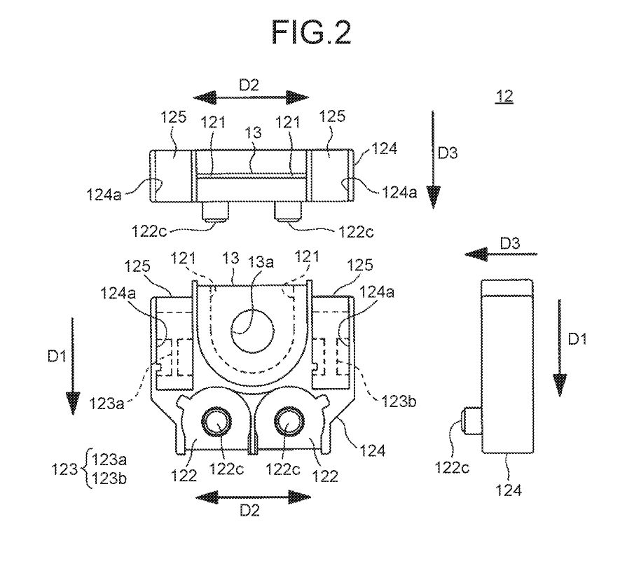

A fusible link according to a first embodiment of the present invention will be described with reference to FIGS. 1 to 4. FIG. 1 is three orthographic views illustrating a fuse unit including a fusible link in the first embodiment. FIG. 2 is three orthographic views illustrating the fusible link illustrated in FIG. 1.

A fuse unit 1 illustrated in FIG. 1 is the one that is directly mounted on a rod-shaped electrode 22 projecting from a terminal mounting surface 21 of a battery 2, and includes a battery terminal 11, and a fusible link 12 which is also illustrated in FIG. 2.

The battery terminal 11 is a terminal formed of conductive metal and having a substantially rectangular shape in planar view. On one end side in the longitudinal direction of the battery terminal 11, an electrode insertion hole 111 into which the rod-shaped electrode 22 of the battery 2 is inserted is provided. On the other end side in the longitudinal direction, a screw 112 to couple the battery terminal 11 and the fusible link 12 together is provided. The battery terminal 11 is connected to the rod-shaped electrode 22 of the battery 2 near the one end, and extends toward the other end toward an outer edge 21a of the terminal mounting surface 21.

On the battery terminal 11, a cut 113 that leads to the electrode insertion hole 111 is provided. The electrode insertion hole 111 is configured to reduce the diameter thereof by shrinking the width of the cut 113, and on the battery terminal 11, a fastening screw 114 to shrink the width of the cut 113 is provided. Between a screw head 114a of the fastening screw 114 and a terminal body 11a, a square washer 115 is placed, and the distal end of the fastening screw 114 is screwed on a nut 116 that is placed to sandwich the terminal body 11a with the square washer 115. When the fastening screw 114 is tightened, the distance between the square washer 115 and the nut 116 is shrunk and, as a result, the width of the cut 113 is shrunk, and thereby the electrode insertion hole 111 is reduced in diameter. The battery terminal 11 is mechanically fixed to and electrically connected to the rod-shaped electrode 22 as the fastening screw 114 is tightened in a state that the rod-shaped electrode 22 is inserted into the electrode insertion hole 111, and as the electrode insertion hole 111 is reduced in diameter.

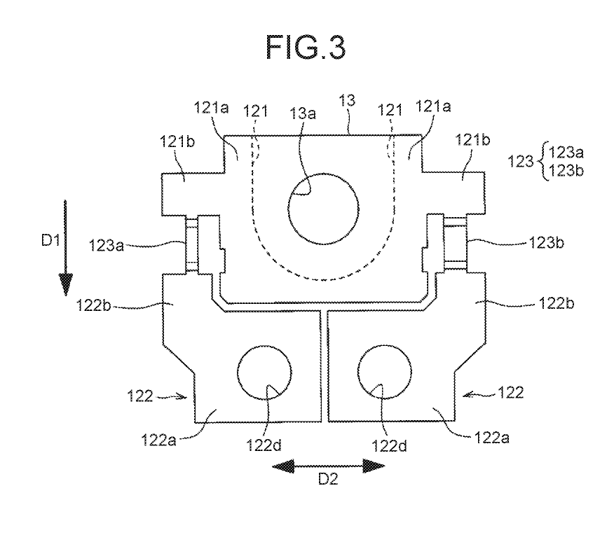

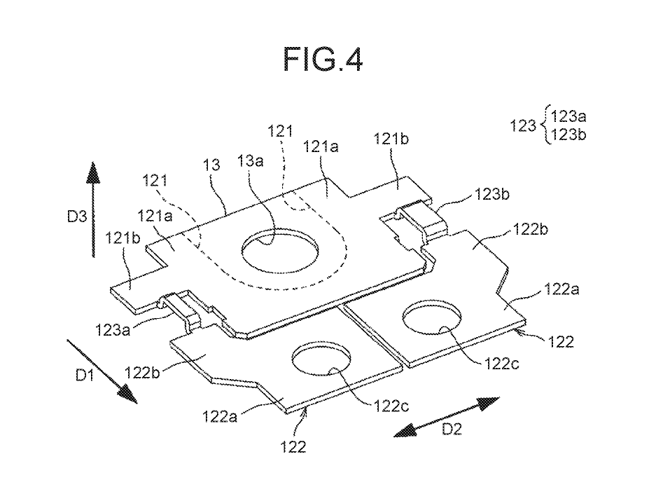

The fusible link 12 is formed with a power supply portion 121, two circuit terminals 122, and fuse elements 123 provided on a connection terminal 13 and housed inside a resin housing 124 composed of insulating resin material. FIG. 3 is a planar view illustrating a structure object including the power supply portion, the two circuit terminals, and the fuse elements provided on the connection terminal in the fusible link illustrated in FIGS. 1 and 2. FIG. 4 is a perspective view illustrating the structure object illustrated in FIG. 3.

To the connection terminal 13, the battery terminal 11 is connected. The power supply portion 121 is provided on this connection terminal 13 in an integrated manner. The power supply portion 121 and the connection terminal 13 are formed of conductive metal in an integrated manner in a plate shape and are disposed substantially in parallel with the terminal mounting surface 21. The connection terminal 13 on which the power supply portion 121 is provided is in a substantially quadrate shape in planar view. On the connection terminal 13, provided is an insertion hole 13a into which the screw 112 of the battery terminal 11 is inserted. The screw 112 inserted into the insertion hole 13a is fastened with a nut 117, and thereby the battery terminal 11 is connected to the connection terminal 13. The power supply portion 121 is supplied with the electrical power via the battery terminal 11 and the connection terminal 13. This power supply portion 121 includes a power-supply body portion 121a and power-supply arm portions 121b.

The power-supply body portion 121a is provided on the connection terminal 13 so as to surround the above-described insertion hole 13a in a C-shape opened on the battery terminal 11 side.

The power-supply arm portions 121b are provided on the power-supply body portion 121a one on each side in a total of two. Each of the power-supply arm portions 121b extends from the power-supply body portion 121a in an intersecting direction D2 that intersects with an extending direction D1 of the battery terminal 11 and is substantially in parallel with the terminal mounting surface 21.

Each of the two circuit terminals 122 is formed of conductive metal in a plate shape and is disposed substantially in parallel with the terminal mounting surface 21, and a non-depicted circuit that operates by the electrical power from the battery 2 is connected to. Each circuit terminal 122 is disposed so as to form a plane substantially the same as the power supply portion 121 provided on the connection terminal 13, and includes a circuit terminal body 122a and a circuit-terminal arm portion 122b.

The circuit terminal body 122a is in a substantially quadrate shape in planar view and, in the middle thereof, is provided with an insertion hole 122d into which a connection screw 122c for connecting the non-depicted circuit, which operates by the electrical power from the battery 2, to this circuit terminal 122 is inserted. In the first embodiment, two pieces of the circuit terminal bodies 122a are disposed in front leaving a gap with the power-supply body portion 121a in the above-described extending direction D1 viewed from the power-supply body portion 121a, and the two are disposed in juxtaposition in the above-described intersecting direction D2. To the circuit terminal body 122a, a round terminal and the like attached to the distal end of an electrical wire extending from the non-depicted circuit is connected by being inserted to the connection screw 122c and fastened with a nut.

One each of the circuit-terminal arm portions 122b extends from each of the two circuit terminal bodies 122a to a position being adjacent to the power-supply arm portion 121b leaving a gap with the power-supply arm portion 121b.

Two pieces of the fuse elements 123 formed of conductive metal are provided in a belt-like shape narrower in width than the power supply portion 121 and the circuit terminals 122 so as to connect the power supply portion 121 and the respective two circuit terminals 122. The fuse element 123 fuses when a current equal to or greater than a threshold value flows. In the first embodiment, as illustrated in FIGS. 1 to 4, of the two fuse elements 123, a fuse element 123a of the left-hand side in the drawings is formed narrower in width than a fuse element 123b of the right-hand side in the drawings. Consequently, the fuse element 123a of the left-hand side in FIGS. 1 to 4 functions as a small-capacity fuse that fuses by a current smaller than that of the fuse element 123b of the right-hand side in the drawings.

Each of these two fuse elements 123, as illustrated in FIG. 4, has a bent shape so as to project in an out-of-plane direction D3 of the terminal mounting surface 21. More specifically, each fuse element 123 connects the power-supply arm portion 121b and the circuit-terminal arm portion 122b.

The fusible link 12 in the first embodiment, as illustrated in FIG. 2, is formed with the structure object including the power supply portion 121, the two circuit terminals 122, and the two fuse elements 123 provided on the connection terminal 13, by molding with the insulating resin material. The resin housing 124 composed of the insulating resin material covers and fixes a part of the above-described structure object in a state that the connection surfaces of the connection terminal 13 and each of the circuit terminals 122 are exposed and windows 124a are provided such that the fusing of the fuse elements 123 is visible. This resin housing 124 is formed in an integrated manner with the above-described structure object by insert molding. This insert molding is performed in a state that the connection screw 122c is being inserted into the insertion hole 122d of the circuit terminal 122. On the window 124a for viewing of fusing in the resin housing 124, a transparent cover 125 is put on, and the fusing of the fuse element 123 is visible through this transparent cover 125.

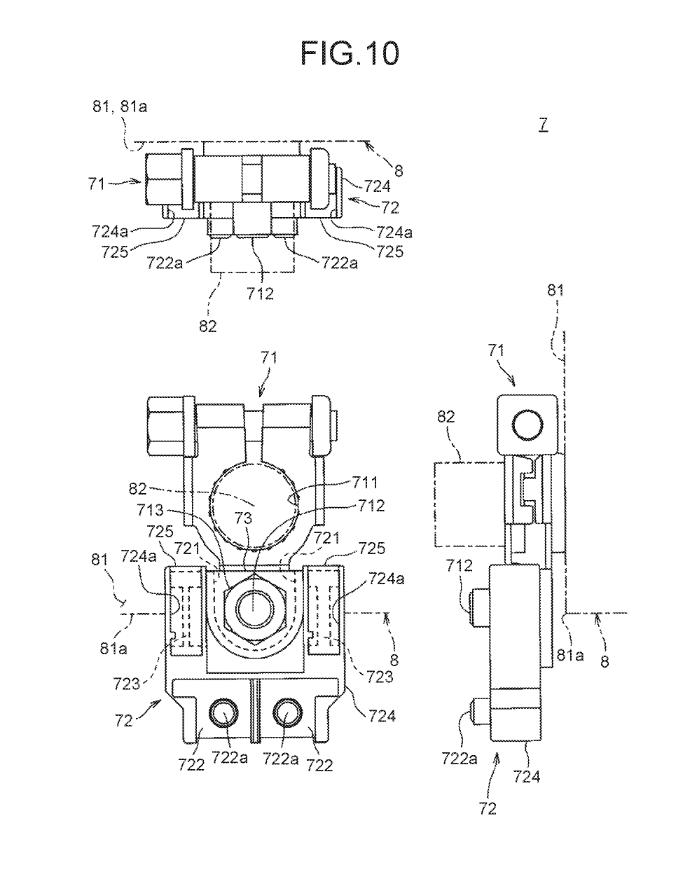

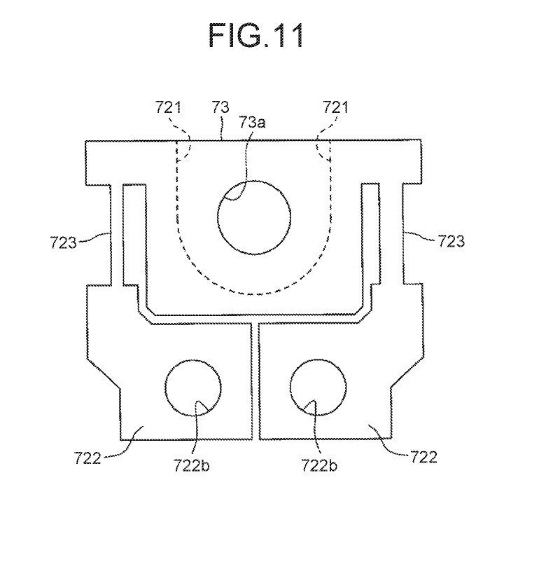

According to the fusible link 12 in the above-described first embodiment, the fuse element 123 has a shape projecting in the out-of-plane direction D3 of the terminal mounting surface 21. Consequently, an adequate length of the fuse element 123 to obtain a resistance value required for fusing can be ensured while the length of the fuse element 123 in planar view viewed from the out-of-plane direction D3 is shortened. As a result, the interval between the power supply portion 121 and the circuit terminals 122 can be cut down, and thereby the fusible link 12 in the first embodiment is downsized, as compared with the conventional fusible link 72 illustrated in FIG. 10, for example. Furthermore, being different from the first embodiment, by leaving the interval between the power supply portion and the circuit terminals as is and configuring a fusible link as the same size as that of the conventional fusible link 72, a fuse element of higher resistance can be achieved by lengthening the length of the fuse element.

Moreover, according to the fusible link 12 in the first embodiment, the power-supply arm portions 121b and the circuit-terminal arm portions 122b extending in the above-described intersecting direction D2 are provided, and the fuse elements 123 connect the power-supply arm portions 121b and the circuit-terminal arm portions 122b. As a result, the fuse elements 123 can be formed in an adequate length while the interval in the above-described extending direction D1 between the power-supply body portion 121a and the circuit terminal body 122a is further cut down. Consequently, the fusible link 12 in the first embodiment further achieves downsizing in the extending direction D1.

According to the fusible link 12 in the first embodiment, the fuse element 123 connects the edge of the front side in the extending direction D1 of the power-supply arm portion 121b and the edge of the rear side in the extending direction D1 of the circuit-terminal arm portion 122b. As a result, the fuse element 123 is extended along the extending direction D1, and thereby the fusible link 12 achieves further downsizing in the extending direction D1.

In the first embodiment, as one example of a fuse element that connects a power-supply arm portion and a circuit-terminal arm portion in the present invention, the fuse element 123 connecting the edge of the front side in the extending direction D1 of the power-supply arm portion 121b and the edge of the rear side in the extending direction D1 of the circuit-terminal arm portion 122b has been exemplified as in the foregoing. The fuse element that connects the power-supply arm portion and the circuit-terminal arm portion in the present invention, however, is not limited to this, and it may be the one that follows a substantially C-shaped alternative route which, in planar view, extends from the power-supply arm portion in the intersecting direction, bends by 90°, extends in the extending direction, further bends by 90°, and reaches the circuit-terminal arm portion, for example.

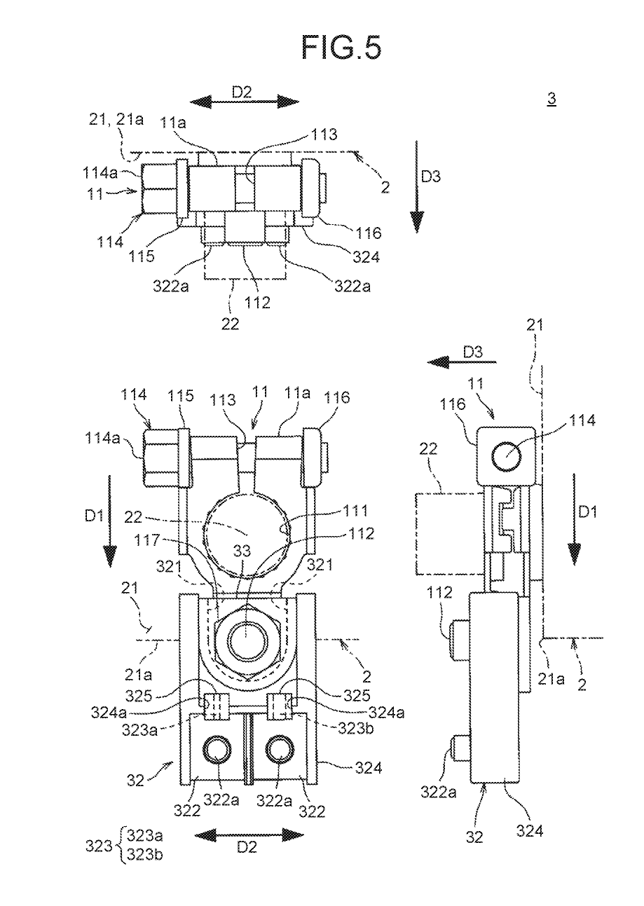

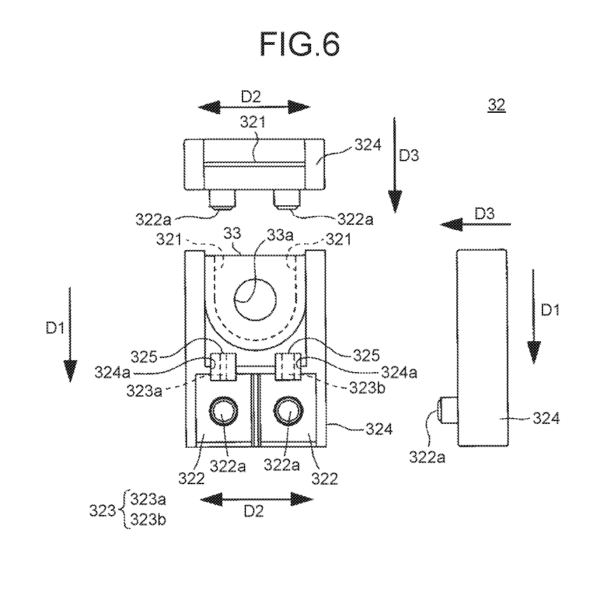

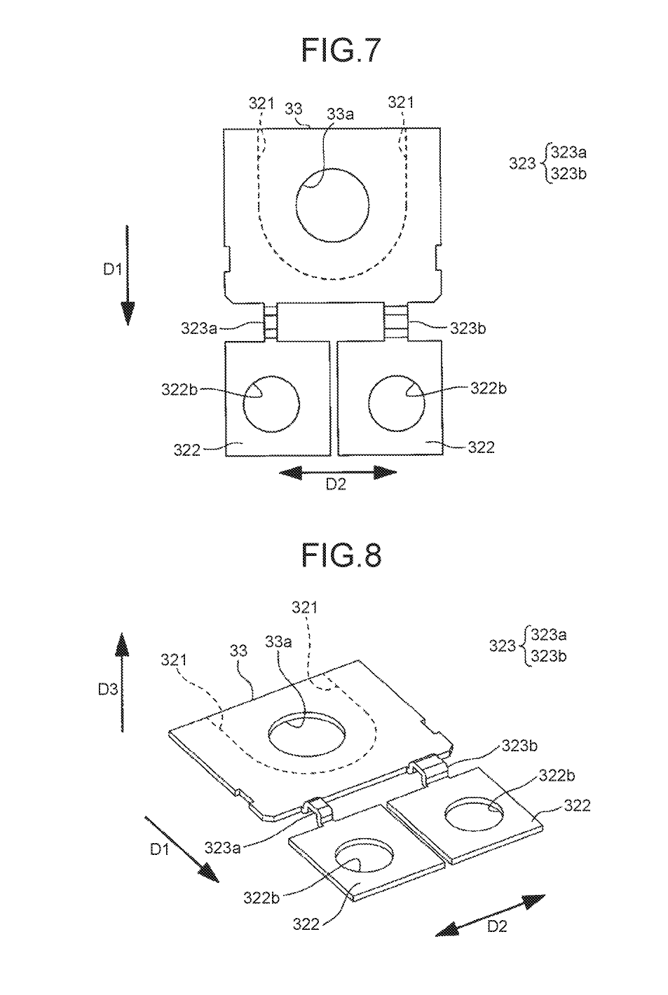

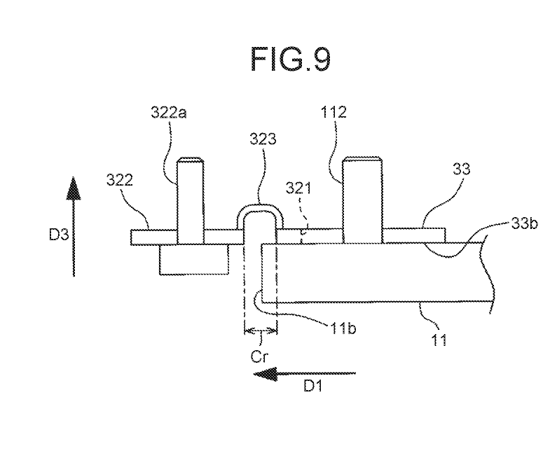

Next, with reference to FIGS. 5 to 9, a fusible link according to a second embodiment of the present invention will be described. FIG. 5 is three orthographic views illustrating a fuse unit including a fusible link in the second embodiment. FIG. 6 is three orthographic views illustrating the fusible link illustrated in FIG. 5. FIG. 7 is a planar view illustrating a structure object including a power supply portion, two circuit terminals, and fuse elements provided on a connection terminal in the fusible link illustrated in FIGS. 5 and 6. FIG. 8 is a perspective view illustrating the structure object illustrated in FIG. 7. FIG. 9 is a side view illustrating the positional relation between the fuse element and a battery terminal illustrated in FIGS. 7 and 8. In the second embodiment also, the battery and the battery terminal are the same as the battery 2 and the battery terminal 11 in the first embodiment illustrated in FIG. 1. Thus, in FIGS. 5 and 9, the battery and the battery terminal have the same reference signs as those in FIG. 1, and the redundant explanations on the battery and the battery terminal are omitted.

A fusible link 32 in the second embodiment that a fuse unit 3 illustrated in FIG. 5 includes is, as the same as the above-described fusible link 12 of the first embodiment, also formed with a power supply portion 321, two circuit terminals 322, and fuse elements 323 provided on a connection terminal 33 and housed inside a resin housing 324 composed of insulating resin material.

To the connection terminal 33, the battery terminal 11 is connected. The power supply portion 321 is provided on this connection terminal 33 in an integrated manner. The power supply portion 321 and the connection terminal 33 are formed of conductive metal in an integrated manner in a plate shape and are disposed substantially in parallel with the terminal mounting surface 21. The connection terminal 33 on which the power supply portion 321 is provided is in a substantially quadrate shape in planar view. On the connection terminal 33, provided is an insertion hole 33a into which the screw 112 of the battery terminal 11 is inserted. The screw 112 inserted into the insertion hole 33a is fastened with the nut 117, and thereby the battery terminal 11 is connected to the connection terminal 33. The power supply portion 321 is supplied with the electrical power via the battery terminal 11 and the connection terminal 33.

In the second embodiment, the power supply portion 321, being different from the power supply portion 121 in the first embodiment, is not provided with power-supply arm portions, and is provided on the connection terminal 33 so as to surround the above-described insertion hole 33a in a C-shape opened on the battery terminal 11 side.

Each of the two circuit terminals 322 is formed of conductive metal in a plate shape and is disposed substantially in parallel with the terminal mounting surface 21, and a non-depicted circuit that operates by the electrical power from the battery 2 is connected to. Each circuit terminal 322 is disposed so as to form a plane substantially the same as that of the power supply portion 321. Each circuit terminal 322 is not provided with a circuit-terminal arm portion as in the first embodiment, is in a substantially quadrate shape in planar view, and in the middle thereof, is provided with an insertion hole 322b into which a connection screw 322a for connecting a non-depicted circuit, which operates by the electrical power from the battery 2, to this circuit terminal 322 is inserted. To the circuit terminal 322, a round terminal and the like attached to the distal end of an electrical wire extending from the non-depicted circuit is connected by being inserted to the connection screw 322a and fastened with a nut.

In the second embodiment, two pieces of the circuit terminals 322 are disposed in front leaving a gap with the power supply portion 321 in the extending direction D1 of the battery terminal 11 viewed from the power supply portion 321, and the two are disposed in juxtaposition in the intersecting direction D2 that intersects with the extending direction D1 and is substantially in parallel with the terminal mounting surface 21. As illustrated in FIGS. 7 and 8, in the second embodiment, the disposed width of these two circuit terminals 322 in the intersecting direction D2 substantially matches the width in the intersecting direction D2 of the connection terminal 33 on which the power supply portion 321 is provided.

Two pieces of the fuse elements 323 formed of conductive metal are provided in a belt-like shape narrower in width than the power supply portion 321 and the circuit terminals 322 so as to connect the edge of the front side in the extending direction D1 of the power supply portion 321 and the respective edges of the rear side in the extending direction D1 of the two circuit terminals 322. The fuse element 323 fuses when a current equal to or greater than a threshold value flows. In the second embodiment, as illustrated in FIGS. 5 to 8, of the two fuse elements 323, a fuse element 323a on the left-hand side in the drawings is formed narrower in width than a fuse element 323b on the right-hand side in the drawings. Consequently, the fuse element 323a on the left-hand side in FIGS. 5 to 8 functions as a small-capacity fuse that fuses by a current smaller than that of the fuse element 323b on the right-hand side in the drawings. Each of these two fuse elements 323, as illustrated in FIG. 8, has a bent shape so as to project in the out-of-plane direction D3 of the terminal mounting surface 21.

The fusible link 32 in the second embodiment, as illustrated in FIG. 6, is formed with the structure object including the power supply portion 321, the two circuit terminals 322, and the two fuse elements 323 provided on the connection terminal 33, by molding with the insulating resin material. The resin housing 324 including the insulating resin material covers and fixes a part of the above-described structure object in a state that the connection surfaces of the connection terminal 33 and each of the circuit terminals 322 are exposed and windows 324a are provided such that the fusing of the fuse elements 323 is visible. This resin housing 324 is formed in an integrated manner with the above-described structure object by insert molding. This insert molding is performed in a state that the connection screw 322a is being inserted into the insertion hole 322b of the circuit terminal 322. On the window 324a for viewing of fusing in the resin housing 324, a transparent cover 325 is put on, and the fusing of the fuse element 323 is visible through this transparent cover 325.

The fusible link 32 in the above-described second embodiment also, as the same as that of the fusible link 12 in the first embodiment, achieves downsizing by forming the fuse element 123 to have a projecting shape.

Furthermore, according to the fusible link 32 in the second embodiment, the circuit terminal 322 is disposed in front in the extending direction D1 of the power supply portion 321, and the fuse elements 323 connect the power supply portion 321 and the circuit terminals 322. Consequently, as compared with a case in which the power-supply arm portions and the circuit-terminal arm portions are provided as in the first embodiment, the fusible link 32 in the second embodiment achieves further downsizing in the intersecting direction D2.

According to the fusible link 32 in the second embodiment, the fuse element 323 connects the edge of the front side in the extending direction D1 of the power supply portion 321 and the edge of the rear side in the extending direction D1 of the circuit terminal 322. As a result, the fuse element 323 is extended along the extending direction D1, and thereby the fusible link 32 achieves further downsizing in the extending direction D1 also, in addition to the intersecting direction D2.

In the second embodiment, as one example of a fuse element that connects a power supply portion and a circuit terminal in the present invention, the fuse element 323 connecting the edge of the front side in the extending direction D1 of the power supply portion 321 and the edge of the rear side in the extending direction D1 of the circuit terminal 322 has been exemplified as in the foregoing. The fuse element that connects the power supply portion and the circuit terminal in the present invention, however, is not limited to this, and it may be the one that follows a substantially C-shaped alternative route which, in planar view, extends from the power supply portion in the intersecting direction, bends by 90°, extends in the extending direction, further bends by 90°, and reaches the circuit terminal, for example.

As illustrated in FIG. 9, the battery terminal 11 is connected to a surface 33b on the opposite side of the projecting side of the fuse element 323, out of the front and rear surfaces of the connection terminal 33. At this time, a gap Cr is left between the power supply portion 321 and the circuit terminal 322. However, in the second embodiment, a distal end 11b in the extending direction D1 of the battery terminal 11 is connected to the above-described surface 33b on the opposite side such that it sticks out toward the gap Cr from the power supply portion 321 to a position overlapping the fuse element 323. Because the fuse element 323 is bent and projecting on the side opposite to the battery terminal 11 side, the battery terminal 11 is connected to the connection terminal 33 in non-contact to the fuse element 323, even though the battery terminal 11 sticks out in such a manner.

According to the fusible link 32 in the second embodiment, the battery terminal 11 is connected in the foregoing manner, and thereby the fuse unit 3 in combination of the battery terminal 11 and the fusible link 32 achieves shortening of the size in the extending direction D1 for the overlapping portion of the battery terminal 11 and the fuse element 323.

The two embodiments in the foregoing merely exemplify a typical form of the present invention, and the present invention is not intended to be limited to those embodiments. That is, various modifications can be implemented without departing from the scope of the spirit of the present invention. Naturally, even with such a modification, it is included in the scope of the present invention as long as the configuration of the fusible link of the present invention is included.

For example, in both the above-described first and second embodiments, as examples of a power supply portion in the present invention, the power supply portion 121 or 321 provided on the connection terminal 13 or 33 to which the battery terminal 11 is connected has been exemplified. The power supply portion in the present invention, however, is not limited to these, and it may be the one provided on the other end side that is opposite to the one end side of the battery terminal to which the rod-shaped electrode is connected. In this case, the fuse elements are formed so as to connect in a belt-like shape the power supply portion provided on the battery terminal, and the circuit terminals.

In both the above-described first and second embodiments, as examples of a fusible link in the present invention, the fusible link 12 or 32 in a form that two pieces of the circuit terminals 122 or 322 are provided and that a single piece of the fuse element 123 or 323 is provided for each of the circuit terminals 122 or 322 has been exemplified. The fusible link in the present invention, however, is not limited to this form, and it may be in a form provided with the circuit terminal of a single piece, or three or more pieces. When a plurality of circuit terminals are provided, the fuse elements may not be provided on all of the circuit terminals, and it may be in a form that the fuse elements are provided only on the circuit terminals to which the circuits that need the protection by fusing are connected.

As examples of a fuse element in the present invention, in both the above-described first and second embodiment, the fuse element 123 or 323 that linearly connects, in planar view, the power supply portion 121 or 321 and the circuit terminal 122 or 322 has been exemplified. The fuse element in the present invention, however, is not limited to these, and as long as it is bent in the above-described out-of-plane direction D3, the shape in planar view may be in a meander shape, for example, and a specific shape does not matter.

As examples of a circuit terminal in the present invention, in both the above-described first and second embodiment, the circuit terminal 122 or 322 that is in a plate shape and disposed substantially in parallel with the terminal mounting surface 21 of the battery 2 has been exemplified. The circuit terminal in the present invention, however, may be the one that is disposed substantially in parallel with the side surface orthogonal to the terminal mounting surface of the battery, and the one that is of a shape bent into an L-shape, for example.

For example, the circuit terminal in the present invention may be a modified one in which the circuit terminal 122 in the first embodiment illustrated in FIGS. 3 and 4 is bent into an L-shape at the circuit-terminal arm portion 122b near the fuse element 123 such that the circuit terminal body 122a is substantially in parallel with the side surface of the battery 2. Alternatively, it may be a modified one in which the circuit terminal 322 in the second embodiment illustrated in FIGS. 7 and 8 is bent into an L-shape at the power supply portion 321 near the fuse element 323 or at the circuit terminal 122 near the fuse element 323 such that at least a part of the circuit terminal 122 is substantially in parallel with the side surface of the battery 2, for example.

As in the foregoing, as long as the circuit terminal in the present invention is a terminal to which the circuit that operates by the electrical power from the battery is connected, the specific arrangement and shape thereof do not matter.

According to one aspect of the present invention, the fuse element has a shape projecting in the out-of-plane direction of the terminal mounting surface. Consequently, an adequate length of the fuse element to obtain a resistance value required for fusing can be ensured while the length of the fuse element in planar view viewed from the out-of-plane direction of the terminal mounting surface is shortened. As a result, the interval between the power supply portion and the circuit terminal can be cut down, and thereby the fusible link can be downsized. Furthermore, by leaving the interval between the power supply portion and the circuit terminal as is, a fuse element of higher resistance can also be achieved.

According to another aspect of the present invention, the power-supply arm portion and the circuit-terminal arm portion extending in the intersecting direction are provided, and the fuse element connects the power-supply arm portion and the circuit-terminal arm portion. Consequently, the fuse element can be formed in an adequate length while the interval in the extending direction between the power-supply body portion and the circuit terminal body is further cut down, and thus the fusible link can be further downsized.

According to still another aspect of the present invention, the fuse element connects the edge of the front side in the extending direction of the power-supply arm portion and the edge of the rear side in the extending direction of the circuit-terminal arm portion. As a result, the fuse element can be extended along the extending direction and thus the fusible link can be further downsized in the extending direction.

According to still another aspect of the present invention, the circuit terminal is disposed in front in the extending direction of the power supply portion and the fuse element connects those power supply portion and the circuit terminal. Consequently, in the intersecting direction, as compared with a case in which the power-supply arm portion and the circuit-terminal arm portion are provided as in the foregoing, the fusible link can be further downsized.

According to still another aspect of the present invention, the fuse element connects the edge of the front side in the extending direction of the power supply portion and the edge of the rear side in the extending direction of the circuit terminal. As a result, the fuse element can be extended along the extending direction and thus the fusible link can be further downsized in also the extending direction in addition to the intersecting direction.

According to still another aspect of the present invention, the battery terminal is connected to the connection terminal such that the battery terminal sticks out toward the gap from the power supply portion to a position overlapping the fuse element. Consequently, in a structure object in combination of the battery terminal and the fusible link, the size in the extending direction can be shortened for the overlapping portion of the battery terminal and the fuse element.

Although the present invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fusible link comprising:
a power supply portion provided on other end side of a battery terminal that is formed of conductive metal, connected at and near one end of the battery terminal to a rod-shaped electrode projecting from a terminal mounting surface of a battery, and extending toward an outer edge of the terminal mounting surface toward the other end of the battery terminal, or provided on a connection terminal that is formed of conductive metal in a plate shape, disposed substantially in parallel with the terminal mounting surface, and connected to the other end side of the battery terminal;
a circuit terminal connected to a circuit that is operated by electrical power from the battery; and
a fuse element that is formed of conductive metal, connecting the power supply portion and the circuit terminal in a belt-like shape narrower in width than the power supply portion and the circuit terminal, and fusing when a current equal to or greater than a threshold value flows, wherein
the fuse element has a shape projecting in an out-of-plane direction with respect to at least one surface of the terminal mounting surface and a surface of the circuit terminal.

2. The fusible link according to claim 1, wherein
the power supply portion includes a power-supply body portion, and a power-supply arm portion extending from the power-supply body portion in an intersecting direction that intersects with an extending direction of the battery terminal and is substantially in parallel with the terminal mounting surface,
the circuit terminal includes a circuit terminal body disposed in front leaving a gap with the power-supply body portion in the extending direction viewed from the power-supply body portion, and a circuit-terminal arm portion extending from the circuit terminal body to a position being adjacent to the power-supply arm portion leaving a gap with the power-supply arm portion, and
the fuse element connects the power-supply arm portion and the circuit-terminal arm portion.

3. The fusible link according to claim 2, wherein
the fuse element connects an edge of the front side in the extending direction of the power-supply arm portion and an edge of a rear side in the extending direction of the circuit-terminal arm portion.

4. The fusible ink according to claim 1, wherein
the circuit terminal is disposed in front leaving a gap with the power supply portion in an extending direction of the battery terminal viewed from the power supply portion, and
the fuse element connects the power supply portion and the circuit terminal.

5. The fusible link according to claim 4, wherein
the fuse element connects an edge of a front side in the extending direction of the power supply portion and an edge of a rear side in the extending direction of the circuit terminal.

6. The fusible link according to claim 4, wherein
the power supply portion is provided on the connection terminal and is connected to the battery terminal on a surface on an opposite side of a projecting side of the fuse element out of front and rear surfaces of the connection terminal, and
the battery terminal is connected to the surface on the opposite side such that the battery terminal sticks out toward the gap from the power supply portion to a position overlapping the fuse element when viewed from the out-of-plane direction.

7. The fusible link according to claim 5, wherein
the power supply portion is provided on the connection terminal and is connected to the battery terminal on a surface on an opposite side of a projecting side of the fuse element out of front and rear surfaces of the connection terminal, and
the battery terminal is connected to the surface on the opposite side such that the battery terminal sticks out toward the gap from the power supply portion to a position overlapping the fuse element when viewed from the out-of-plane direction.
